(19) United States
(12) Patent Application Publication
(10) Pub. No.: US 2022/0044555 A1
(43) Pub. Date: Feb. 10, 2022

(54) IN-VEHICLE DETECTION DEVICE AND DETECTION METHOD

(71) Applicant: Toyota Jidosha Kabushiki Kaisha, Toyota-shi Aichi-ken (JP)

(72) Inventors: Kazuki Horiba, Sunto-gun (JP); Hiroki Saito, Sunto-gun (JP); Mitsuhiro Kinoshita, Mishima-shi (JP)

(73) Assignee: Toyota Jidosha Kabushiki Kaisha, Toyota-shi Aichi-ken (JP)

(21) Appl. No.: 17/235,209

(22) Filed: Apr. 20, 2021

(30) Foreign Application Priority Data
Aug. 6, 2020 (JP) 2020-133714

(51) Int. Cl. G08G 1/01; G06K 9/00

(52) U.S. Cl. CPC G08G 1/0141; G06K 9/00791; G08G 1/0133; G08G 1/0145

(57) ABSTRACT

An in-vehicle detection device is mounted on a vehicle. The in-vehicle detection device includes a camera configured to capture a first range around the vehicle as the capturing range, a sensor different in type from the camera and configured to measure a second range as the measurement range with the second range overlapping with at least a part of the first range, and a processor configured to perform detection processing on an image captured by the camera. The processor is configured to identify a first area that is included in the image and is excluded from the target of the detection processing based on the measurement result of the sensor and is configured to perform the detection processing on a second area that is included in the image and is not included in the first area.

### CROSS-REFERENCE TO RELATED APPLICATION

This application claims priority to Japanese Patent Application No. 2020-133714 filed on Aug. 6, 2020, incorporated herein by reference in its entirety.

### BACKGROUND

### 1. Technical Field

The present disclosure relates to the technique field of an in-vehicle detection device and detection method.

### 2. Description of Related Art

For example, as a device of this type, an image processing device is proposed that determines whether a vehicle is parked in a parking frame, based on an image captured by a monocular camera mounted on the vehicle (see Japanese Unexamined Patent Application Publication No. 2020-095629 (JP 2020-095629 A)).

### SUMMARY

As in the technique described in JP 2020-095629 A, an image captured by an in-vehicle camera is image-processed to detect obstacles around a vehicle. In addition, to realize safe and secure traveling of an autonomously-driven vehicle a plurality of cameras is mounted on the vehicle, high resolution cameras are used as in-vehicle cameras, and the capturing frequency of the in-vehicle cameras is increased. This increases the amount of calculation related to image processing. As a result, a high-performance arithmetic unit is required for appropriately performing image processing. However, a high-performance arithmetic unit has technical problems that the cost is relatively high and its size is relatively large.

The present disclosure provides an in-vehicle detection device that can reduce load on image processing and detection method.

A first aspect of the present disclosure relates to an in-vehicle detection device mounted on a vehicle. The in-vehicle detection device includes a camera, a sensor, and a processor. The camera is configured to capture a first range as the capturing range. The first range is a range around the vehicle. The sensor is configured to measure a second range as the measurement range. The second range overlaps with at least a part of the first range. The sensor is different in type from the camera. The processor is configured to perform detection processing on an image captured by the camera. The processor is configured to identify a first area that is included in the image and is excluded from the target of the detection processing based on the measurement result of the sensor and is configured to perform the detection processing on a second area that is included in the image and is not included in the first area.

A second aspect of the present disclosure relates to a detection method. The detection method includes, performing detection processing on an image captured by a camera mounted on a vehicle, identifying a first area that is included in the image and is excluded from a target of the detection processing based on a measurement result of a sensor mounted on the vehicle, and performing the detection processing on a second area that is included in the image and is not included in the first area. The camera is configured to capture a first range as a capturing range and the first range is a range around the vehicle. The sensor is configured to measure a second range as a measurement range. The second range is overlapping with at least a part of the first range and the sensor being different in type from the camera.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing the configuration of an in-vehicle detection device according to a first embodiment;

FIG. 2A is an example of an image captured by a camera;

FIG. 2B is an example of an image captured by a camera;

FIG. 3 is flowchart showing the operation of the in-vehicle detection device according to the first embodiment;

FIG. 4 is another example of an image captured by the camera; and

FIG. 5 is a flowchart showing the operation of the in-vehicle detection device according to a second embodiment.

### DETAILED DESCRIPTION OF EMBODIMENTS

Embodiments of an in-vehicle detection device will be described with reference to the drawings.

### First Embodiment

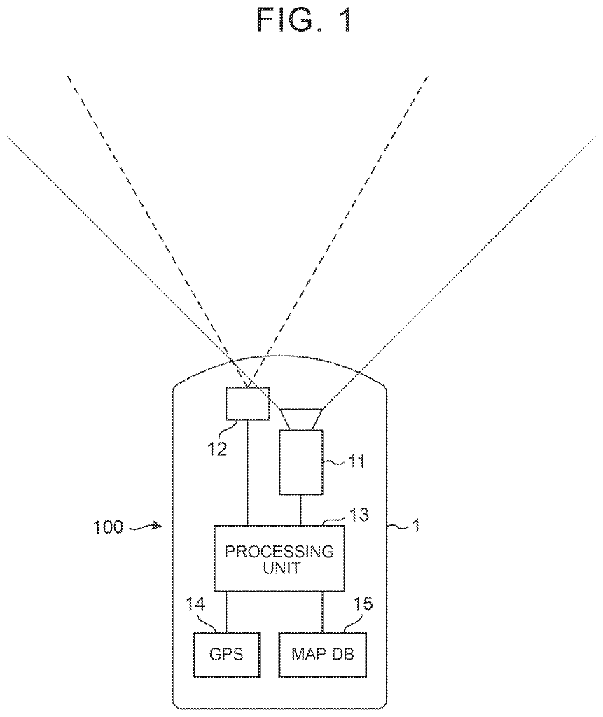

A first embodiment of the in-vehicle detection device will be described with reference to FIG. 1 to FIG. 3. In FIG. 1, an in-vehicle detection device 100 is mounted on a vehicle 1. The in-vehicle detection device 100 includes a camera 11, a sensor 12, a processing unit 13, a Global Positioning System (GPS) 14, and a map database 15. In FIG. 1, the dotted line shows an example of the capturing range of the camera 11, and the broken line shows an example of the measurement range of the sensor 12.

The sensor 12 is a sensor different in type from the camera 11. As the sensor 12, a millimeter-wave radar, a Light Detection and Ranging (LiDAR), a far infrared rays (FIR) sensor, an ultrasonic sensor (also referred to as “sonar”), a time-of-flight (TOF) sensor, etc. can be used. In other words, the sensor 12, which can be used to detect an object, is a sensor different in type from the camera 11.

Although only one sensor 12 is shown in FIG. 1, the in-vehicle detection device 100 may include a plurality of the sensor 12. In this case, the plurality of the sensors 12 are not limited to sensors of the same type but may include a mixture of different types of sensors.

The processing unit 13 detects obstacles around the vehicle 1 by performing image processing for the images captured by the camera 11. The processing unit 13 also detects obstacles around the vehicle 1 based on the measurement result of the sensor 12. In the description below, obstacles detected based on the measurement result of the sensor 12 are referred, as necessary, to as “surrounding object information”. Since known techniques can be applied to the method for detecting obstacles from the images and to the method for detecting surrounding object information, the detailed description thereof will be omitted.

Note that, in the process of image processing, floating-point arithmetic is frequently performed. Therefore, arithmetic load on image processing becomes relatively large. This arithmetic load increases as the resolution of an image to be image-processed increases and as the number of images to be image-processed increases.

On the other hand, in the process of detecting surrounding object information, integer arithmetic is frequently performed. Integer arithmetic has arithmetic load smaller than that of floating-point arithmetic. Therefore, the arithmetic load on the processing for detecting surrounding object information is smaller than the arithmetic load on the image processing.

The surrounding object information is, for example, the relative position (distance), or relative speed, between the vehicle 1 and an object. On the other hand, not only the shape and type of an object but also the color of the object, the characters and figures drawn on the object, etc. can be acquired from an image captured by the camera 11.

For example, to realize safe and secure traveling of an autonomously-driven vehicle, not only the information on the relative position and relative speed of obstacles around the vehicle 1 but also the information other than that on the relative position and relative speed, such as the information on the colors of a traffic light, the information on the lighting/blinking of the brake lamp and the blinker of a vehicle traveling ahead of the vehicle 1, and the information on the recognition result of road signs, is required. This means that, to realize safe and secure traveling, the information obtained from the images captured by the camera 11 becomes more important.

However, as described above, the arithmetic load on image processing is relatively large. In addition, since the environment around the vehicle 1 changes from moment to moment, the time for processing one image is limited. Therefore, if no measures are taken, a high-performance arithmetic unit will be required as the processing unit 13. In addition, since a high-performance arithmetic unit generates a relatively large amount of heat, a heat radiating member must be added to the arithmetic unit with the result that its size becomes relatively large. The problem that arises here is that it becomes difficult to procure an arithmetic unit within an expected cost range or to arrange the arithmetic unit in the planned mounting space.

To address this problem, the in-vehicle detection device 100 reduces arithmetic load on image processing as follows. That is, before performing image processing on the images captured by the camera 11, the processing unit 13 detects obstacles around the vehicle 1 based on the measurement result of the sensor 12. At this time, the processing unit 13 checks the area included in the capturing range of the camera 11 and, based on the measurement result of the sensor 12, excludes an area where an obstacle detected with sufficient reliability is present and an area where an obstacle that does not become a threat to the traveling of the vehicle 1 is present from the target of image processing.

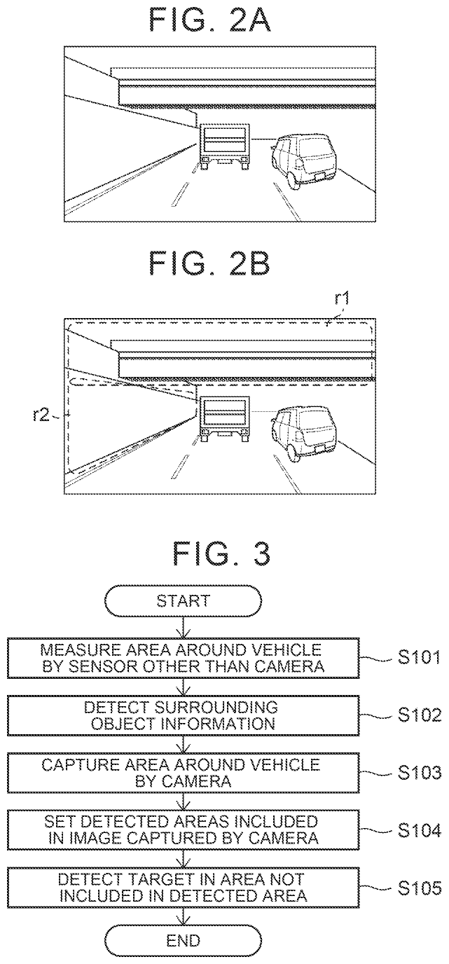

For example, when the image shown in FIG. 2A is captured by the camera 11, the overhead structure (for example, a bridge), under which the vehicle 1 will pass, does not become a threat to the vehicle 1 (in other words, the structure will not collide with the vehicle 1). Therefore, the processing unit 13 excludes area r1, included in the image and surrounded by the broken line frame in FIG. 2B, from the target of image processing. Similarly, the structure (for example, the wall) existing on the side of the vehicle 1 does not become a threat to the vehicle 1. Therefore, the processing unit 13 excludes area r2, included in the image in FIG. 2B and surrounded by the broken line frame, from the target of image processing. In the description below, an area excluded from the target of image processing in this way is referred to as a “detected area” as necessary.

After that, the processing unit 13 performs image processing on the part that is captured by the camera 11 but is not included in the detected areas and then detects obstacles around the vehicle 1.

Next, the operation of the in-vehicle detection device 100 will be described with reference to the flowchart in FIG. 3.

As shown in FIG. 3, the sensor 12 (that is, the sensor other than the camera 11) measures the area around the vehicle 1 (step S101). Next, based on the measurement result of the sensor 12, the processing unit 13 detects obstacles around the vehicle 1 (that is, surrounding object information) (step S102).

In parallel with the processing in steps S101 and S102, the camera 11 captures the area around the vehicle 1 (step S103). Next, the processing unit 13 sets the detected areas (that is, the areas to be excluded from the target of image processing) in the image, captured by the camera 11, based on the surrounding object information detected in the processing in step S102 (step S104).

Next, the processing unit 13 performs image processing on a part that is included in the image captured by the camera 11 but is not included in the detected areas that has been set in the processing in step S104, and detects obstacles (that is, targets to be detected) around the vehicle 1 (step S105). Then, after a predetermined time (for example, several tens of milliseconds to several hundreds of milliseconds) has elapsed, the processing in step S101 is performed. That is, the operation shown in FIG. 3 is repeated at a cycle corresponding to the predetermined time.

### Technical Effect

As described above, the in-vehicle detection device 100 performs image processing on a part of an image that is captured by the camera 11 but is not included in the detected areas. Since the detected areas are excluded from the target of image processing (in other words, the part to be image processed is narrowed down), the arithmetic load on image processing can be reduced. In addition, the time required for image processing used for one image can be reduced.

The in-vehicle detection device 100 can reduce arithmetic load on image processing, making it possible to reduce the performance required for the arithmetic unit implemented as the processing unit 13. As a result, the in-vehicle detection device 100 can reduce the cost of the arithmetic unit implemented as the processing unit 13 and, at the same time, reduce its size.

At least one of a millimeter wave radar, a LiDAR, a far infrared ray sensor, an ultrasonic sensor, and a TOF sensor is used as the sensor 12. Using these sensors relatively reduces arithmetic load on detecting the surrounding object information. This is because, in the process of processing for detecting the surrounding object information from the measurement results of these sensors, integer arithmetic, with a load smaller than that of floating-point arithmetic, is performed. In this case, even if the processing is increased for detecting the surrounding object information from the measurement results of these sensors and for setting the detected areas, the total arithmetic load on the processing unit 13 is smaller than that required for performing image processing on all the whole image captured by the camera 11. In addition, since these sensors have a proven capability in detecting objects (for example, a capability in detecting the relative position and relative speed between the vehicle 1 and an object), relatively reliable surrounding object information can be detected from the measurement results of these sensors.

Modification

In the processing in step S104 described above, the processing unit 13 may further exclude, from the target of image processing, an area in the image where the brightness is equal to or smaller than a predetermined value and an area where a plurality of objects is estimated to be overlapping in the image.

In an area where the brightness is equal to or smaller than a predetermined value (for example, an area in darkness), there is a high possibility that obstacles cannot be detected by image processing. Therefore, the arithmetic load on image processing can be further reduced by excluding an area where the brightness is equal to or smaller than a predetermined value from the target of image processing. In addition, in an area where a plurality of objects is estimated to be overlapping in an image, correct results cannot be obtained by image processing in many cases. Therefore, the occurrence of erroneous detection can be reduced by excluding an area where a plurality of objects is estimated to be overlapping in an image from the target of image processing.

The “predetermined value” described above is a value for determining whether an area is in darkness. This predetermined value may be set as a fixed value in advance or may be set as a value that varies according to some physical quantity or according to parameters. To determine such a predetermined value, the relationship between the brightness and the detection accuracy of an obstacle through image processing is obtained empirically or experimentally or by simulation. After that, based on the obtained relationship, the predetermined value may be set as a brightness at which the detection accuracy becomes relatively poor.

### Second Embodiment

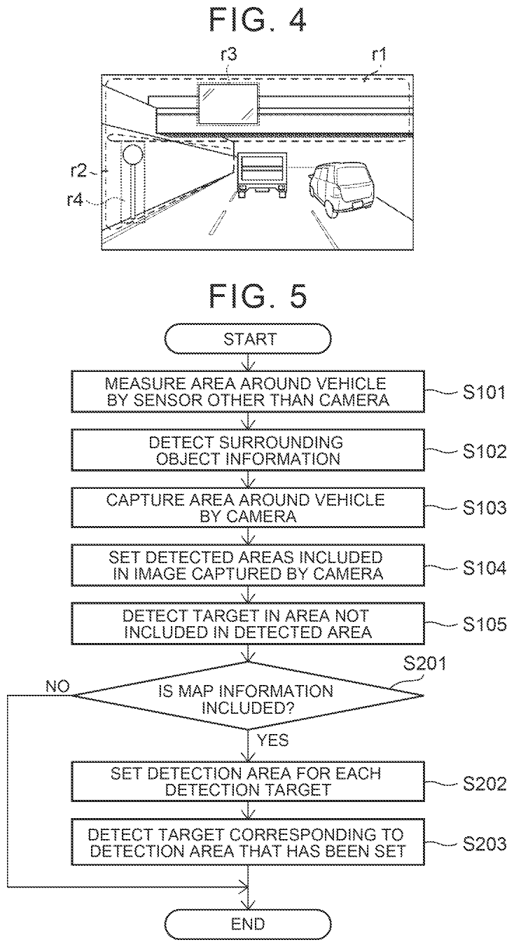

A second embodiment of an in-vehicle detection device will be described with reference to FIG. 4 and FIG. 5. The second embodiment is the same as the first embodiment described above, except that the operation of the processing unit 13 is partially different. Therefore, the description of the second embodiment that overlaps with the description of the first embodiment is omitted, the common parts in the drawings are shown with the same reference numerals, and the basically different parts are described with reference to FIGS. 4 and 5.

In the first embodiment described above, the detected areas (see “area r1” and “area r2” in FIG. 4) may include the information that affects the traffic of the vehicle 1, such as a traffic light, a road sign, and a guide board. For example, the colors of a traffic light and the contents of a road sign cannot be recognized from the measurement results of the sensor 12.

The processing unit 13 of the in-vehicle detection device 100 acquires the map information around the vehicle 1 from the map database 15 based on the position of the vehicle 1 identified by the GPS 14. Then, based on the acquired map information, the processing unit 13 identifies a part of the detected areas where the information affecting the traffic is included

The map information included in the map database 15 may include, for example, the information indicating traffic lights, road signs, guide boards, on-road markings, and construction sections. In addition, the map information included in the map database 15 may be serially updated by communicating with an external device (for example, a server) of the vehicle 1.

For example, when it is detected that the vehicle 1 is approaching an intersection based on the map information, the processing unit 13 may identify a part of the detected area of the image, captured by the camera 11, where the traffic light is estimated to be located, considering the distance from the vehicle 1 to the intersection. Based on the information indicating a construction section included in the map information, the processing unit 13 may identify a part of the detected area of the image, captured by the camera 11, where road cones are estimated to be placed.

The processing unit 13 performs image processing on a part that is included in a detected area excluded from the target of image processing but is estimated to include the information affecting the traffic. For example, the processing unit 13 performs image processing on part r3 that is included in detected area r1 of the image shown in FIG. 4 but is estimated to include the information (for example, a guide board) affecting the traffic. The processing unit 13 performs image processing on part r4 that is included in detected area r2 of the image shown in FIG. 4 but is estimated to include the information (for example, a road sign) affecting the traffic.

Next, the operation of the in-vehicle detection device 100 will be described with reference to the flowchart in FIG. 5.

In FIG. 5, after the processing in step S105 described above, the processing unit 13 determines whether the map information is included (step S201). When it is determined in the processing in step S201 that the map information is included (step S201: Yes), the processing unit 13 identifies, based on the map information, a part that is included in a detected area but is estimated to include the information affecting the traffic and, then, sets a detection area including the part (“detection area for each detection target” in FIG. 5: for example, the area corresponds to “area r3” and the area corresponding to “area r4” in FIG. 4) (step S202).

Next, the processing unit 13 performs image processing on each detection area, which has been set as described above, to detect the target (that is, the information affecting traffic) (step S203). Then, after a predetermined time has elapsed, the processing in step S101 is performed.

When it is determined in the processing in step S201 that the map information is not included (step S201: No), the operation shown in FIG. 5 is terminated. Then, after a predetermined time has elapsed, the processing in step S101 is performed. Note that “the map information is not included” not only means that the map information itself is not included but may mean, for example, that the map information does not include the information indicating traffic lights or the like.

### Technical Effect

The in-vehicle detection device 100 configured in this way makes it possible to detect information that affects the traffic of the vehicle 1 while reducing arithmetic load on image processing.

### Application Example

Application examples of the in-vehicle detection device 100 according to the first embodiment or the second embodiment will be described. In the examples given below, the detection result of the in-vehicle detection device 100 is used for the collision determination control of the vehicle 1.

For example, based on the detection result of the in-vehicle detection device 100, the electronic control unit (ECU), mounted on the vehicle 1, identifies an object with a collision may occur. Note that the object may be a stationary object or a moving object.

The ECU calculates the time for the vehicle 1 to reach the identified object (for example, Time to Collision: TTC, etc.). Then, based on the calculated time, the ECU determines whether the vehicle 1 and the object are likely to collide.

When this determination indicates that the vehicle 1 and the object are likely to collide, the ECU issues an alarm or warning to the driver of the vehicle 1 or controls various actuators for decelerating and/or steering the vehicle 1.

As described above, the in-vehicle detection device 100 excludes an area including an obstacle that does not become a threat to the vehicle 1 from the target of image processing. Therefore, the result detected by the in-vehicle detection device 100 does not include the information on an object that will never collide with the vehicle 1. This means that using the result detected by the in-vehicle detection device 100 makes it possible to narrow an object with a collision may occur in advance. As a result, the processing load on collision determination can be reduced.

Various aspects of the disclosure derived from the above-described embodiments and modifications will be described below.

The in-vehicle detection device in one aspect of the present disclosure is an in-vehicle detection device mounted on a vehicle. The in-vehicle detection device includes a camera configured to capture a first range around the vehicle as the capturing range, a sensor different in type from the camera and configured to measure a second range as the measurement range with the second range overlapping with at least a part of the first range, and a processor configured to perform detection processing on an image captured by the camera. The processor is configured to identify a first area that is included in the image but is excluded from the target of the detection processing based on the measurement result of the sensor and is configured to perform the detection processing on a second area that is included in the image but is not included in the first area.

In the embodiments described above, the “processing unit 13” corresponds to an example of the “processor”, the “image processing” corresponds to an example of the “detection processing”, a “detected area” corresponds to an example of the “first area”, and a “part that is included in an image captured by the camera 11 but is not included in the detected areas” corresponds to an example of the “second area”.

In one aspect of the in-vehicle detection device, the processor is configured to identify a part that is included in the first area but is estimated to include information affecting traffic based on map information and is configured to perform the detection processing on the part as well as on the second area.

In another aspect of the in-vehicle detection device, the sensor is at least one of a millimeter wave radar, a LiDAR, a far infrared ray sensor, an ultrasonic sensor, and a TOF sensor.

It is to be understood that the present disclosure is not limited to the embodiments described above but may be changed as appropriate within the scope of claims and within the spirit and the concept of the present disclosure understood from this specification and that an in-vehicle detection device to which such changes are added is also included in the technical scope of the present disclosure.

What is claimed is:

1. An in-vehicle detection device mounted on a vehicle, the in-vehicle detection device comprising:
a camera configured to capture a first range as a capturing range, the first range being a range around the vehicle;
a sensor configured to measure a second range as a measurement range, the second range overlapping with at least a part of the first range, the sensor being different in type from the camera; and
a processor configured to perform detection processing on an image captured by the camera, wherein the processor is configured to identify a first area that is included in the image and is excluded from a target of the detection processing based on a measurement result of the sensor and is configured to perform the detection processing on a second area that is included in the image and is not included in the first area.

2. The in-vehicle detection device according to claim 1, wherein the processor is configured to identify a part that is included in the first area and is estimated to include information affecting traffic based on map information and is configured to perform the detection processing on the part as well as on the second area.

3. The in-vehicle detection device according to claim 1, wherein the sensor is at least one of a millimeter wave radar, a Light Detection and Ranging, a far infrared ray sensor, an ultrasonic sensor, and a time-of-flight sensor.

4. A detection method comprising:
performing detection processing on an image captured by a camera mounted on a vehicle, the camera configured to capture a first range as a capturing range and the first range being a range around the vehicle;
identifying a first area that is included in the image and is excluded from a target of the detection processing based on a measurement result of a sensor mounted on the vehicle, the sensor configured to measure a second range as a measurement range, the second range overlapping with at least a part of the first range and the sensor being different in type from the camera; and
performing the detection processing on a second area that is included in the image and is not included in the first area.

5. The method according to claim 4, further comprising:
identifying a part that is included in the first area and is estimated to include information affecting traffic based on map information; and
performing the detection processing on the part as well as on the second area.

6. The method according to claim 4, wherein the sensor is at least one of a millimeter wave radar, a Light Detection and Ranging, a far infrared ray sensor, an ultrasonic sensor, and a time-of-flight sensor.
